(19) United States
(12) Patent Application Publication
(10) Pub. No.: US 2016/0078840 A1
(43) Pub. Date: Mar. 17, 2016

(54) METHODS AND SYSTEMS FOR CONNECTING MULTIPLE DEVICES TO FORM A COMBINED VIRTUAL TOUCH SCREEN

(71) Applicant: Sharp Electronics Corporation, Mahwah, NJ (US)

(72) Inventors: Kimiyoshi KUSAKA, San Jose, CA (US); Kazuaki IZUTANI, Cupertino, CA (US)

(73) Assignee: Sharp Electronics Corporation, Mahwah, NJ (US)

(21) Appl. No.: 14/489,066

(22) Filed: Sep. 17, 2014

(51) Int. Cl. G09G 5/00; G06F 3/14; G06F 3/041

(52) U.S. Cl. CPC G09G 5/003; G06F 3/0416; G06F 3/1446; G09G 2370/022

(57) ABSTRACT

Described herein are methods and systems for connecting multiple mobile devices to form a combined virtual screen display in an easy and intuitive manner. In one embodiment, touch data and device data from multiple devices are received, and based on the received data, a cloud server can determine whether to combine the screen displays of different devices into a single virtual screen display and generate instructions accordingly for the devices to execute.

### FIELD OF THE INVENTION

The present invention relates generally to touch screen technologies, and more particularly, to methods and systems for connecting multiple mobile devices to form a combined virtual touch screen in an easy and intuitive manner.

### BACKGROUND

Driven by the popularity of smartphones, tablets and various information appliances, the display technology in connection with touch screens has advanced tremendously in recent years. As a result, mobile or portable devices, personal computers, TV and many other devices nowadays can be configured with screen displays having narrow edges or no edges, so-called frameless displays. This makes it possible to combine the displays of multiple devices into a single display. For example, if two devices having frameless displays are placed side by side, their displays may be combined to form one big virtual screen with no space or gap in between two displays, thereby providing better viewing experiences for users. However, how to connect the two devices and combine their separate displays into one virtual screen for users to easily operate can be very difficult and complex in terms of actual implementations. Most existing technologies require multiple steps and user inputs to synchronize and consolidate different devices before their displays can be combined into one screen. Therefore, a need exists for an improved solution to this problem.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

In one aspect, the present invention provides a method for connecting multiple mobile devices each of which has a touch screen display, comprising: receiving data from a first device and a second device, respectively, said data including a touch event detected by said first and second devices; based on said received data, determining that said first and second devices are to be connected; and generating instructions for said first and second devices to connect.

In another aspect, the present invention provides a device comprising: a display integrated with a touch screen, said touch screen configured to detect touch inputs in the device; a processor coupled to said touch screen; and a memory accessible to said processor, said memory storing processor-executable instructions, wherein said instructions, while executed, cause said processor to perform: receiving touch information of a touch event detected in said touch screen; sending said touch information and device information to a cloud server, said device information including at least a location of the device; receiving instructions from said cloud server; and based on said instructions, activating a connection mode allowing data exchange with one or more of other devices that are identified by said cloud server.

In another aspect, the present invention provides a device comprising: a display integrated with a touch screen, said touch screen configured for detecting touch inputs in the device; a memory storing process-executable instructions; and a processor having access to said memory, said processor configured for: receiving first touch information of a first touch event detected in said touch screen; receiving second touch information of a second touch event detected in a second device; receiving device information from said second device; and based on said first and second touch information and device information, determining whether to connect said device to said second device.

In another aspect, the present invention provides a non-transitory computer-readable medium comprising processor-executable instructions, which, while executed, cause a processor to perform: receiving data from a first device having a first display and a second device having a second display; based on said received data, determining to combine said first and second displays into a combined virtual screen display; and generating instructions for said first and second devices to connect and form said combined virtual screen display, wherein said data include a touch event detected by said first and second devices.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a high-level overview of an exemplary system in which embodiments of the invention can be implemented;

FIG. 2 is a block diagram of an exemplary mobile device in which embodiments of the invention can be implemented;

FIG. 3 depicts a process of connecting two devices to form a combined virtual screen according to embodiments of the invention;

FIG. 4 provides an alternative view of the process in FIG. 3 according to embodiments of the invention;

FIG. 5 is a flow diagram of an algorithm underlying the process in FIG. 3 according to embodiments of the invention;

FIGS. 6A-C illustrate alternative ways of connecting multiple devices to form a combined virtual screen according to embodiments of the invention;

FIG. 7 demonstrates user operations on a combined virtual screen formed by multiple devices according to embodiments of the invention;

FIG. 8 is a flow diagram of an algorithm underlying the operations in FIG. 7 according to embodiments of the invention;

FIGS. 9A-9C respectively show one touch event for two devices, the coordinates recognized by the two devices, and the relationship between the respective y-coordinates, when the fingertip is symmetrical with respect to the two devices according to embodiments of the invention; and

FIGS. 10A-10C respectively show one touch event for two devices, the coordinates recognized by the two devices, and the relationship between the respective y-coordinates, when the fingertip is asymmetrical with respect to the two devices according to embodiments of the invention.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Embodiments disclosed herein are directed to methods and systems for connecting multiple mobile devices to form a combined virtual screen display in an easy and intuitive manner. In one embodiment, this method comprises the steps of receiving data from a first device and a second device, each of said first and second devices having a screen display; based on said received data, determining to combine the screen displays of said first and second devices; and generating instructions for said first and second devices to connect and form a combined virtual screen display, wherein said data include a touch event detected by said first and second devices.

As partial implementation of the embodiments, a device is configured to include the following: a display integrated with a touch screen, said touch screen configure for detecting touch inputs in the device; a processor coupled to said touch screen; and a memory accessible to said processor, said memory storing processor-executable instructions, wherein said instructions, while executed, cause said processor to perform: receiving touch information of a touch event detected in said touch screen; sending said touch information to a cloud server; receiving instructions from said cloud server; and based on said instructions, activating a screen-combining mode allowing said display to be combined with displays of other devices.

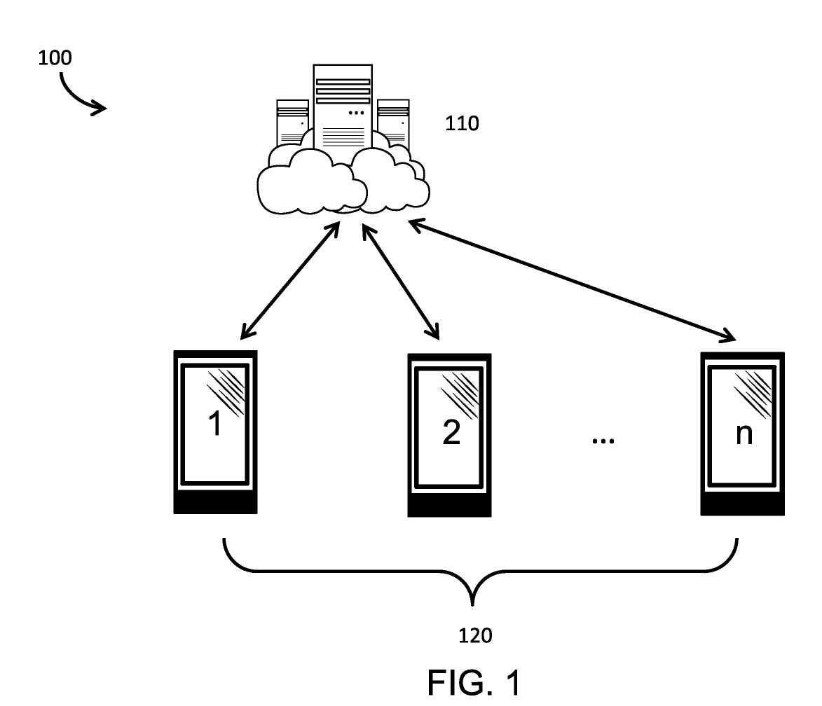

Referring to FIG. 1, illustrated therein is a high-level overview of an exemplary system 100 in which embodiments of the invention can be implemented. As shown in FIG. 1, the system 100 comprises a cloud server 110 and multiple mobile devices 120 in communication with the cloud server. In one embodiment, the devices 120 communicates with the cloud server 110 via a communication network (not shown), which can be one or a combination of the following networks: the Internet, Ethernet, a mobile carrier's core network (e.g., AT&T or Verizon networks), a Public Switched Telephone Network (PSTN), a Radio Access Network (RAN), and any other wired or wireless networks, such as a WiFi (e.g., Bluetooth or Zigbee) or any home network.

The devices 120 may comprise various smartphones such as iPhone, Android phones, and Windows phones. However, the devices 120 are not so limited, but may include many other network devices, including a fixed or mobile subscriber unit, a pager, a cellular telephone, a personal digital assistant (PDA), a smart phone, a laptop, a netbook, a tablet computer, a personal computer, a wireless sensor, consumer electronic devices, and the like.

As illustrated in FIG. 1, most devices 120 have a big screen display with narrow edges or no edges, which allows them to be connected and combined into one single virtual screen. In operation, each device 120 is configured with computer software, executable programs, algorithms, functional modules and processes, such as an application allowing the device to connect with other devices such that their displays can be combined into one single screen, as will be described in detail below.

It should be appreciated that the system 100 in FIG. 1 is for illustration only and can be implemented with many variations without departing from the spirit of the invention. For instance, the cloud server 110 may include multiple computers and stations distributed in different locations.

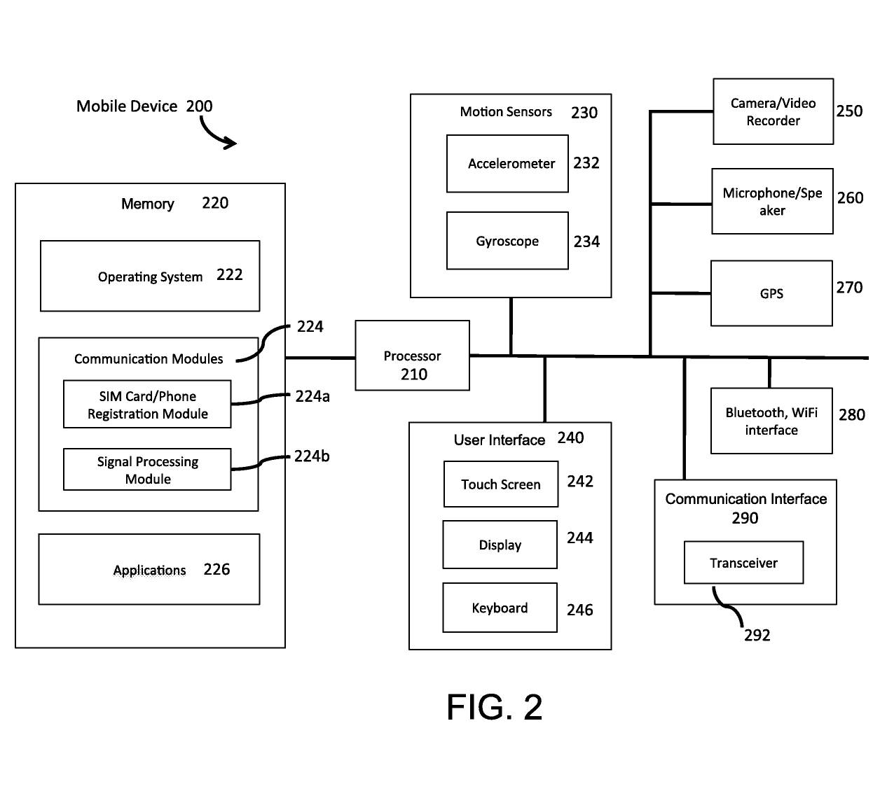

FIG. 2 provides a detailed view of an exemplary mobile device in which embodiments of the invention can be implemented. As shown in FIG. 2, the mobile device 200 comprises a processor 210 and a memory 220 accessible to the processor 210. While the memory 220 is shown as being separate from the processor 210, all or a portion of the memory 220 may be embedded in the processor 210.

The memory 220 includes high-speed random access memory, such as DRAM, SRAM, DDR RAM and/or other random access solid state memory devices, and includes non-volatile memory, such as flash memory devices, a magnetic disk storage device, and/or other non-volatile solid state storage devices. The memory 220, or alternately non-volatile memory device(s) within the memory 220, includes a non-transitory computer-readable storage medium.

In some embodiments, the memory 220 stores the following programs, modules and data structures, or a subset thereof: an operating system 222 that includes procedures for handling various basic system services and for performing hardware dependent tasks, communication modules 224 used for communicating with other devices or network controllers, such as a SIM card or phone registration module 224a and a signal processing module 224b, and various applications 226, including one or more downloaded mobile applications, for example, an application allowing the device to be connected with the cloud server as well as other devices to form a combined virtual screen display. Other applications can be included as well, such as social network or messaging applications, security applications and multimedia applications. All these applications may have associated API(s) (not shown) in the memory 220.

The processor 210 is also coupled to one or more motion sensors 230, including an accelerometer 232 for measuring acceleration, a gyroscope 234 for measuring orientation, or a combination thereof, which is sometimes referred as Inertial Measurement Unit (IMU). Besides, a GPS 270 is coupled to the processor 210 for measuring location information. Usually the combination of motion sensors 230 and GPS 270 allows for an accurate measurement of the position of the device.

To determine the location of the device, in addition to or instead of the GPS, various techniques, for example, WiFi access points, Cellular networks and Bluetooth beacons can be implemented.

In addition, the processor 210 is coupled to a user interface 240 by which the processor communicates with external or peripheral devices, including, without limitation, a touch screen 242, a display 244 and a keyboard 246. The touch screen 242 is typically configured with one or more touch sensors underneath. In some embodiments, the touch screen 242, display 244 and keyboard 246 are integrated into one piece, which is typical of today's touch devices, e.g., smartphones. Other peripheral devices coupled to the processor 210 include a camera or video recorder 250 and a microphone or speaker 260. Usually the memory 220 includes software programs or drivers for activating and communicating with each peripheral device.

The processor 210 is further coupled to a Bluetooth or WiFi interface 280 for receiving local network signals, and a communication interface 290 for connecting wireless or wired networks, mostly through an internal component known as transceiver 292.

In one configuration, all different components in FIG. 2 are connected through one or more communication buses in the mobile device 200, which may include circuitry that interconnects and controls communications between different components. In other configurations, some of the components can be integrated in one circuitry.

Again, it should be appreciated that the mobile device 200 in FIG. 2 is for illustration only and can be implemented with many variations without departing from the spirit of the invention.

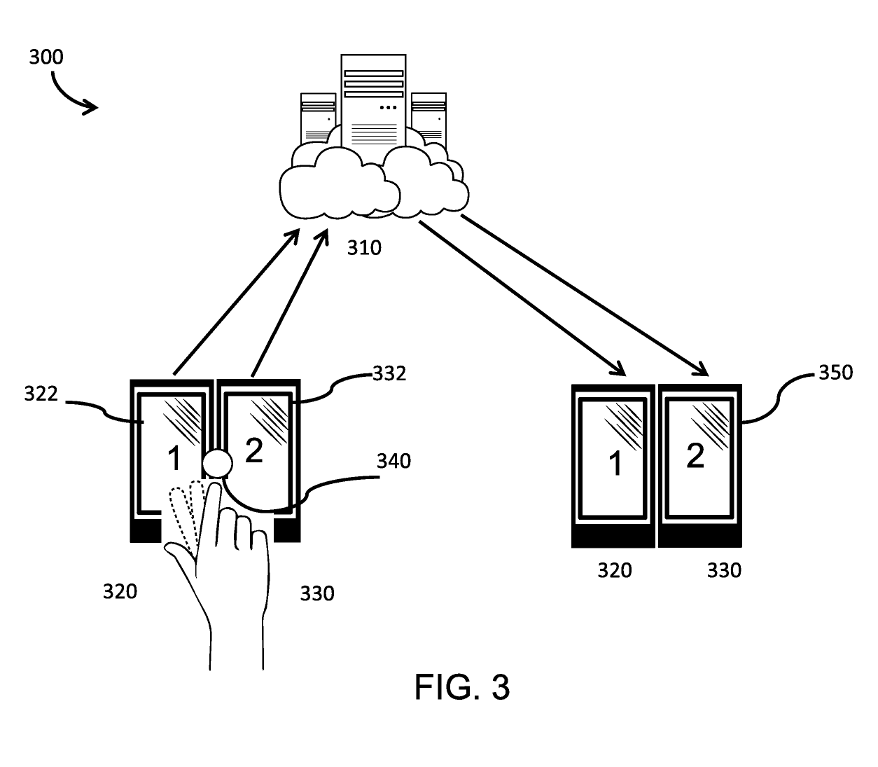

Referring now to FIG. 3, a process of connecting two devices to form a combined virtual screen according to embodiments of the invention will be described. As aforementioned, each of the devices 320 and 330 can communicate with the cloud server 310 wirelessly. Both devices may have a frameless display or a display with very narrow edges, such as the display 322 in the device 320 and the display 332 of the device 330. When the two devices are placed next to each other, they can be connected to form one combined virtual screen according to the process 300 as depicted in FIG. 3.

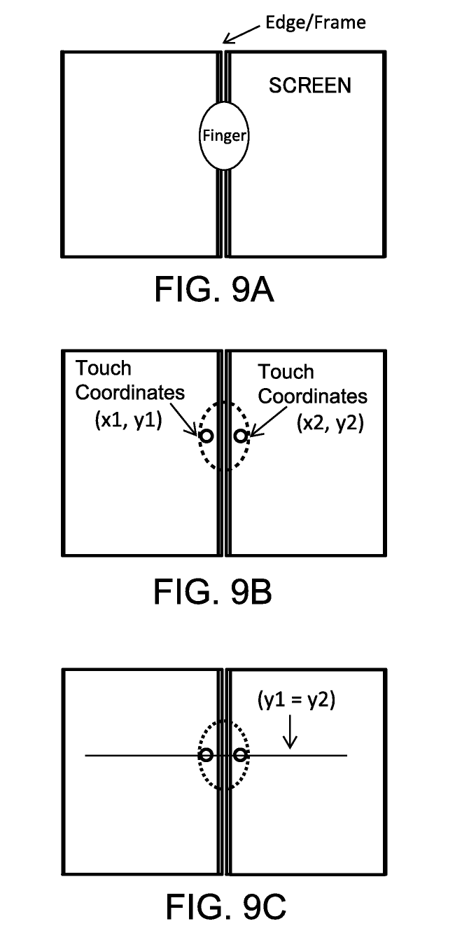

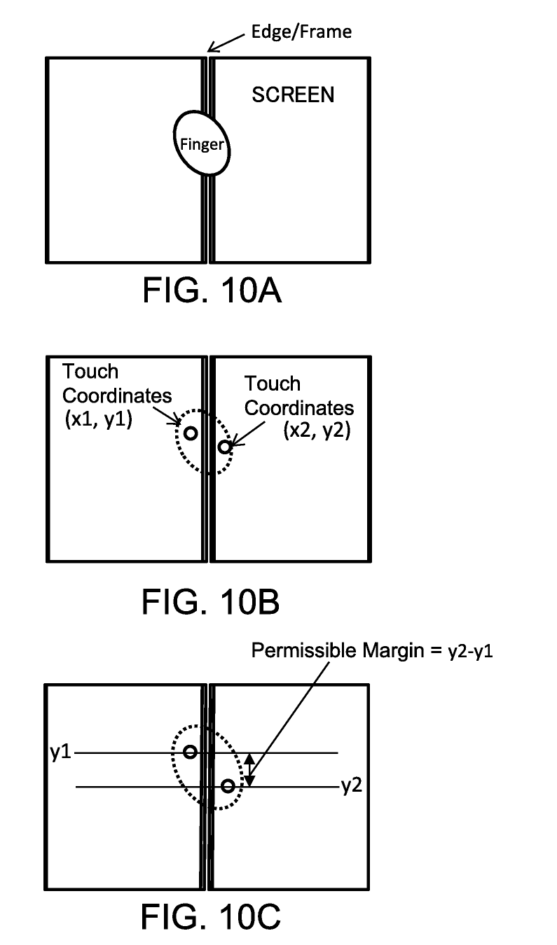

In this process 300, a user may apply a single touch input 340 in the neighboring area of the two devices once they are placed next to each other. This touch input 340 can be detected, almost simultaneously, by each device, or more precisely, the touch sensors embedded underneath the edges of each device. (The manner by which the single touch input in the neighboring area of the two devices is detected will be explained in more detail later with reference to FIGS. 9(a)-9(c) and 10(a)-10(c).) Upon detection of the touch 340, both the device 320 and device 330 send data, including touch information (e.g., coordinates of the touch input, time of the touch, etc.) and device information (e.g., location of the device, direction/orientation of the device, screen resolution, size of the screen, etc.), to the cloud server 310. Based on the data from both devices, the cloud server 310 determines whether the two devices are placed next to each other in such a manner that they are ready to be connected and combined into one virtual screen display. If so, the cloud server 310 sends instructions to the devices for them to connect with each other and activate a pre-installed display-combining application to combine their displays into one virtual screen.

In some embodiments, the two devices 320 and 330 may establish connections with each other without help from the cloud server 310. For example, in a WiFi environment, the two devices 320 and 330 can directly communicate with each other and decide whether they are placed or aligned in a position ready for combining their displays into one bigger screen.

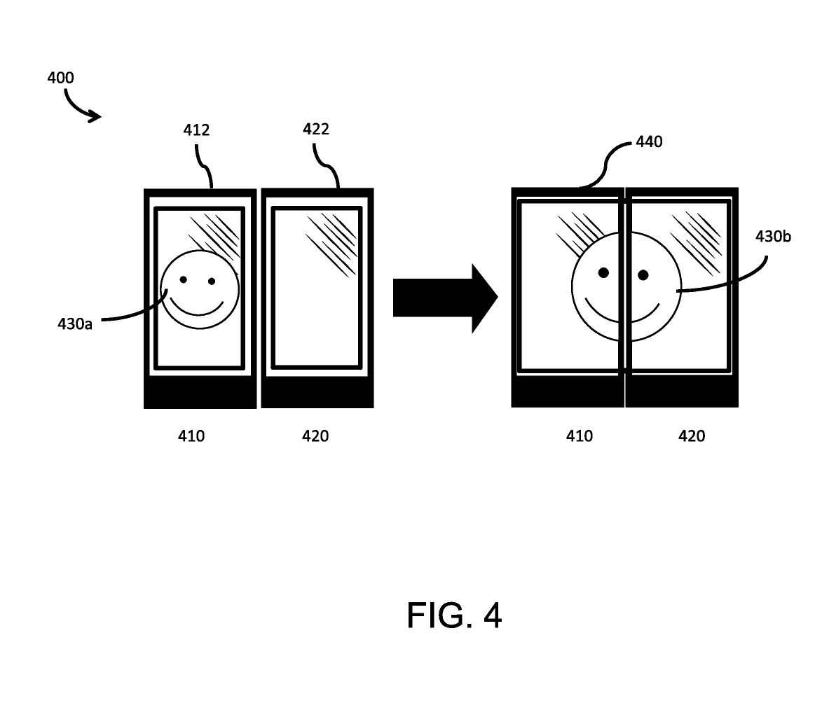

As seen in FIG. 4, before the two devices 410 and 420 can form a combined virtual screen, the device 410 presents an image 430a, the size of which is proportional to and constrained by the size of the device display 412. When the two devices are placed next to each other and connected to form a virtual screen, the combined screen 440 is almost twice as big as either display 412 or 422. As such, the displayed image 430b, proportional to the combined screen size, becomes bigger and better, thereby providing an improved viewing experience. Also, when the two devices are connected and combined, a user can operate the combined virtual device with much ease, as if she is operating a mobile device with a much bigger screen display. Instead of or in addition to establishing a virtual screen, using the above-described scheme, file transfer and file exchange can be performed between two or more devices that are not connected or associated otherwise previously.

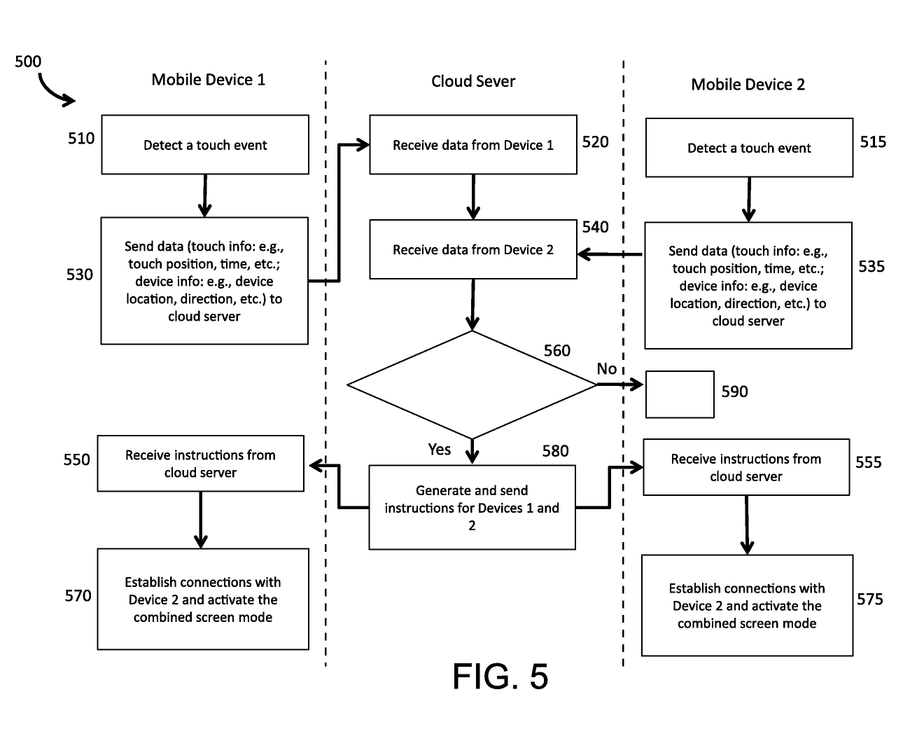

In terms of specific implementations of the above-described functionalities and features, the flow diagram in FIG. 5 provides an algorithm 500 underlying the process in FIG. 3 according to embodiments of the invention.

As shown in FIG. 5, from the standpoint of the mobile device 1, the process starts at step 510 when the device detects a touch event applied to its touch screen or touch bezel at the edge. For example, a user may apply a single touch on the neighboring edges of both devices 1 and 2 when they are placed right next to each other, as described above. Then, at step 530, in response to the detected touch event, the device 1 may generate and send data to the cloud server. The sent data includes both touch information, such as the position and time of the touch, and device information, such as the location and direction of the device. Likewise, the other device, mobile device 2, performs the step 515 of detecting a touch event and step 535 of sending data to the cloud server.

On the cloud server side, data from both devices are received at steps 520 and 540, respectively. It should be noted that the two steps 520 and 540 can occur simultaneously or in slightly different sequences. Based on the received data, at step 560, the cloud server determines whether the two devices are ready to be combined into one virtual device with one combined screen display. More specifically, the cloud server determines from the data whether the two devices are placed next to each other, whether they are readily aligned, whether each device is enabled with the screen-combining function, whether the touch event detected by each device is a user-intended action to combine the displays, and so forth. Also from the data the cloud server can identify each device by their device profiles, such as their device dimensions, system configurations, etc. In some embodiments, for the purpose of establishing connection between two or more devices, the system can be configured such that these devices need not be aligned horizontally (or vertically or in any particular configuration). In particular, when data transfer or exchange is of interest (i.e., not for establishing a virtual screen), two devices placed side-by-side, but misaligned vertically can receive touch input or sequence of touch inputs to identify the devices.

If the cloud server determines that the two device displays are not to be combined, the process may end at step 590. Otherwise, the process proceeds to step 580, where the cloud server generates and sends instructions for the two devices to connect and combine their individual displays into one virtual screen. In one embodiment, the instructions to one device may include information about the other device, such as screen dimensions, connection interface, and so forth.

Once the devices receive the instructions from the cloud server, they can start the screen-combining process. For example, as shown in FIG. 5, once the mobile device 1 receives the instructions from the cloud server at step 550, the device 1 would establish a connection with the mobile device 2 and activate a screen-combining mode in which its screen display can be combined with the display of another device. Almost in parallel, the mobile device 2 receives instructions from the cloud server at step 555, and further, at step 575, it connects with the device 1 and activates a screen-combining mode to form a combined screen display comprising the displays of both devices.

It should be appreciated that the above-described algorithm is for illustration only, and many variations or additional steps may be applied. For example, the two devices can be connected directly in certain network environments without relying on the cloud server. In that case, each device can be configured with such functionalities as determining whether to connect with another device, whether to combine its display with another screen display, how to verify the connection, how to display images in the combined screen, and so forth. In other words, the above-described steps to be performed by the cloud server can be performed by either or both devices.

Further, in some embodiments, in preparation for establishing connections between the two devices, a particular program may be launched in each of the devices. For example, a system can be configured such that unless a particular app is launched in respective smartphones operating under an appropriate OS (such as Android, Windows, or iOS), the smartphones do not send the relevant information to the cloud server 310 (or to adjacent smartphones in case of direct connections) so as to establish the connections.

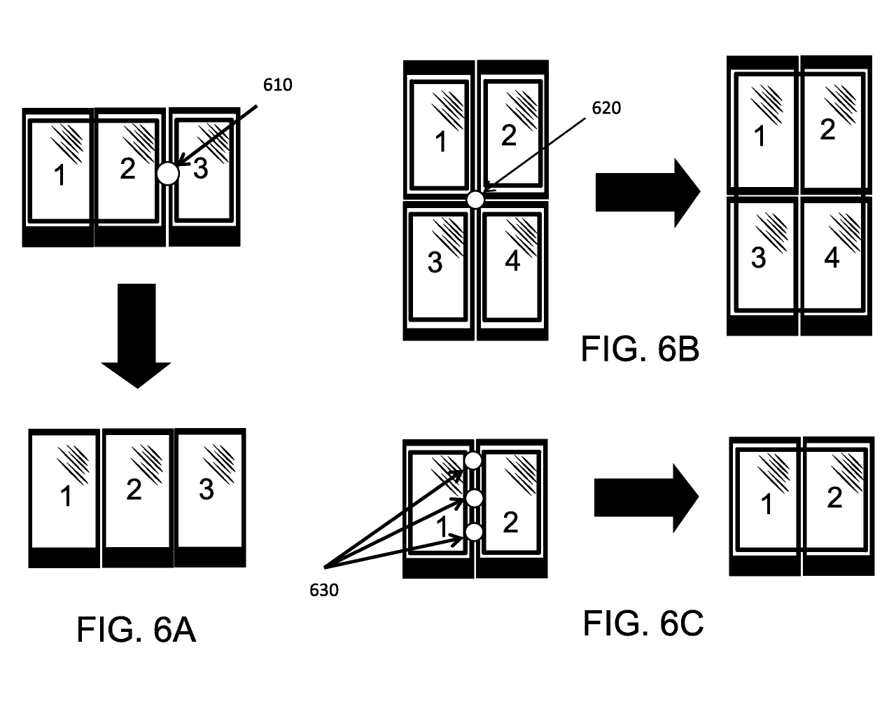

Also, it should be understood that the algorithm in FIG. 5 is exemplary only and embodiments of the invention are not limited to combining the screen displays of two devices, but can be applicable to multiple devices. FIGS. 6A-C illustrate ways of connecting more than two devices to form a combined virtual screen according to embodiments of the invention.

In FIG. 6A, device 1 and device 2 are already in the screen-combing mode to form a combined virtual screen, e.g., screen display “1+2”. When device 3 is placed adjacent to the right edge of device 2 and a combining touch 610 is detected in both devices, a process similar to the above-described with reference to FIGS. 3-5 can be performed to form a combined virtual screen, e.g., screen display “1+2+3.” In the same manner, additional devices can be connected to further expand the combined display horizontally.

Alternatively, multiple devices can be connected and combined as shown in FIG. 6B, where a single touch 620 is detected at the cross-section of four devices to form a combined virtual screen.

In some embodiments, a user can apply a single touch to connect multiple devices to form a combined virtual screen. In other embodiments, a user may apply a sequence of touches, such as the touches 630 in FIG. 6C, to accomplish the same. Such a sequence of touches can be pre-set or configured by users later. For example, a user may specify a sequence of touches as follows: the first touch in the center of the neighboring edge, within two seconds the second touch at the bottom of the edge, and further, after three seconds the third touch at the top of the edge. In some configurations, detection of a sequence of touches along the neighboring edge areas can be used to filter out any accidental touch that is not intended to form a combined screen display. Furthermore, the security can be improved by implementing a user specified or preset sequence of touches that is unique to the devices to be connected and that is highly unlikely to accidentally occur. For example, when electronic money is to be transferred between the devices, the users can set a unique sequence of touches that are only recognized by the devices to be connected, providing the same degree of security like PIN codes.

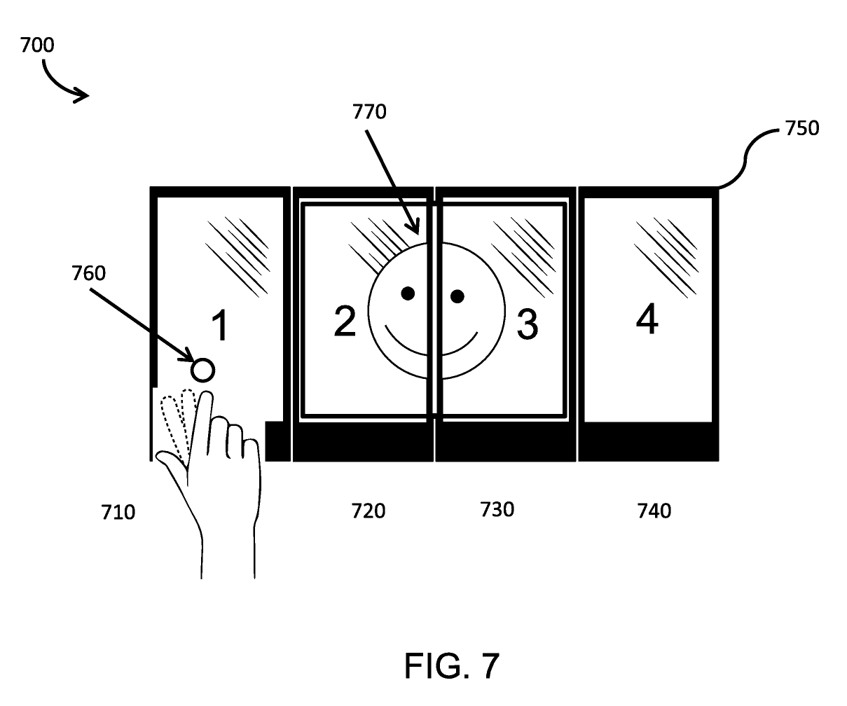

After multiple devices are connected to form a combined virtual screen display, a user can operate the combined devices as if it is a single device. This is demonstrated in FIG. 7, in which four devices 710, 720, 730 and 740 are combined to form a combined virtual screen 750. When a touch input 760 is detected in device 710, the touch information is shared among all four devices so that the image 770 is displayed in the center of the virtual display 750 instead of the display of device 710.

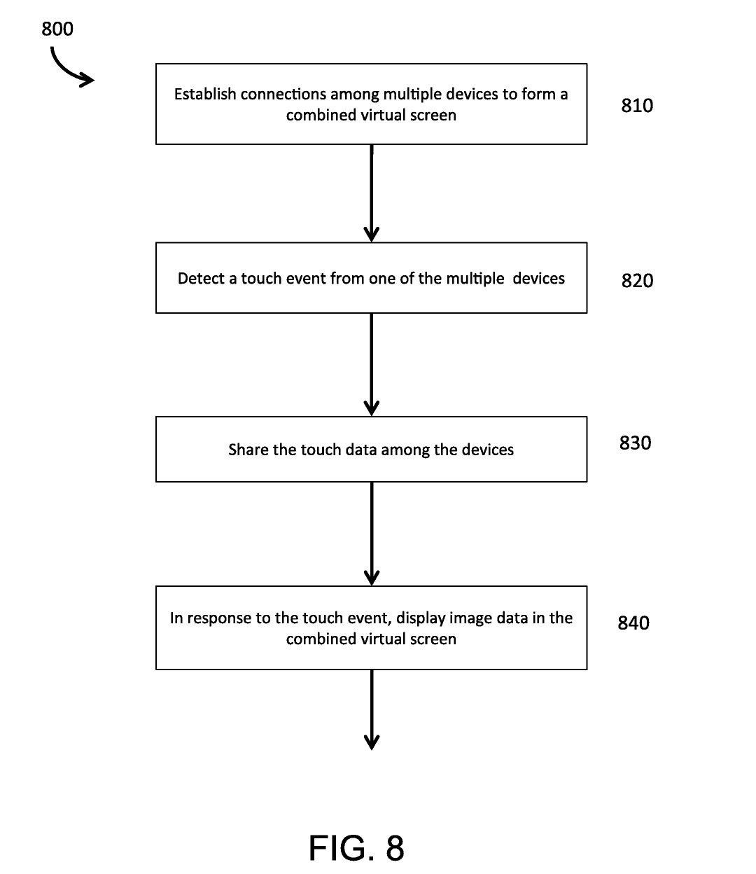

FIG. 8 is a flow diagram of an algorithm for operations after multiple devices are connected to form a combined virtual screen according to embodiments of the invention. As shown in FIG. 8, the algorithm 800 starts at step 810, where connections are established between multiple devices to form a combined virtual screen in accordance with a process as illustrated in FIG. 5. At step 820, a touch event is detected from one of the multiple devices, for example, device 710 in FIG. 7. Then, at step 830, touch data, such as where the touch is detected, what action the touch should trigger, and so forth, is shared amongst all connected devices. For instance, if the user touches a button to display a photo image, the touch information detected by one of the devices receiving the touch will be shared with all other connected devices so that each device can display parts of the image. In this case, if the file for the photo image is not already stored in the other connected devices, the file or portions thereof will be transferred to these devices so that appropriate segments of the image are displayed in the other devices, respectively. As a result, as shown in step 840, in response to the touch event, the photo image is displayed in the combined virtual screen.

Further, at step 830, in addition to or instead of the touch sharing, as described above, any data exchanges or transfer of files/images can be performed between the multiple devices. Moreover, in some embodiments, the virtual screen may not be needed. Once the multiple devices are associated by one or more of the schemes, as described above, these devices are connected (via a cloud server or directly). Thus, data/file exchange or unidirectional data/file transfer can be performed between the connected devices in addition to or instead of establishing a virtual screen.

Again, it should be appreciated that the above-described algorithm is for illustration only, and many variations or additional steps may be applied.

With reference to FIGS. 9A-9C and 10A-10C, the detection of a one touch event that occurs across the boarder portions of the two devices placed side-by-side is described in more detail. FIG. 9A schematically shows one touch event where a fingertip of the user is placed at the border portions in a symmetrical manner with respect to the two devices. As shown in FIG. 9B, the respective devices recognize this touch as occurring at coordinates (x1, y1) and (x2, y2), respectively. As shown in FIG. 9C, y1 equals to y2, and x1 and x2, as recognized by the respective devices, are adjacent to the respective edges of the touch panels. Thus, for such a symmetrical one touch input, the detection of the one touch is relatively straightforward.

FIG. 10A shows the case where the fingertip is placed obliquely relative to the vertical edges. This situation may occur rather frequently in actual use. As shown in FIG. 10B, when the two devices have a finite frame (edge) width, the y-coordinate values y1 and y2 of the touch coordinates (x1, y1) and (x2, y2) are slightly different due to such an asymmetric touch. The difference between y1 and y2 may be larger with devices having larger frame (edge) widths. In order to recognize this type of touch as one touch, as shown in FIG. 10C, a permissible margin for y2−y1 may be provided such that as long as the difference between y1 and y2 is within a permissible threshold value (and when the x-coordinates are adjacent to the respective edges), the touch event can be recognized as one touch input. This way, even with devices having certain finite frame (edge) width, one touch event can be reliability recognized. Accordingly, various features of the present invention described in this disclosure can be applied to not only devices having negligibly small frame widths, but also devices having certain finite frame widths.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These and other forms of computer-readable media may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for connecting multiple mobile devices each of which has a touch screen display, comprising:
receiving data from a first device and a second device, respectively, said data including a touch event detected by said first and second devices;
based on said received data, determining that said first and second devices are to be connected; and
generating instructions for said first and second devices to connect.

2. The method of claim 1, wherein said data further includes location and direction information of said first and second devices.

3. The method of claim 2, further comprising determining from said data whether said first and second devices are placed next to each other.

4. The method of claim 1, wherein said data further includes position and time information of said touch event.

5. The method of claim 4, further comprising:
determining from said data whether said touch event is intended to combine the screen displays of said first and second devices; and
generating instructions for said first and second devices to form a combined virtual screen display

6. The method of claim 1, further comprising connecting said first and second devices through a cloud server, wherein said first and second devices communicate with said cloud server via a communication network.

7. The method of claim 1, further comprising:
establishing connections between said first and second devices;
detecting a touch input in said first device;
sending said touch input to said second device; and
in response to said touch input, activating a display in said combined virtual screen.

8. A device comprising:
a display integrated with a touch screen, said touch screen configured to detect touch inputs in the device;
a processor coupled to said touch screen; and
a memory accessible to said processor, said memory storing processor-executable instructions, wherein said instructions, while executed, cause said processor to perform:
receiving touch information of a touch event detected in said touch screen;
sending said touch information and device information to a cloud server, said device information including at least a location of the device;
receiving instructions from said cloud server; and
based on said instructions, activating a connection mode allowing data exchange with one or more of other devices that are identified by said cloud server.

9. The device of claim 8, wherein said device information further includes an orientation of the device.

10. The device of claim 8, wherein said touch information includes at least a position of said touch event and time of said touch event.

11. The device of claim 8, said instructions, while executed, cause said processor to further perform establishing a connection between said device and other devices in communication with said cloud server.

12. The device of claim 8, wherein said connection mode includes a screen-combining mode that form a virtual screen with said display and displays of said one ore more of the other devices.

13. The device of claim 12, wherein, in said screen-combining mode, said processor is configured for:
detecting a touch input in said device; and
sending data of said touch input to said second device, wherein said virtual screen displays an image in response to said touch input.

14. A device comprising:
a display integrated with a touch screen, said touch screen configured for detecting touch inputs in the device;
a memory storing process-executable instructions; and
a processor having access to said memory, said processor configured for:
receiving first touch information of a first touch event detected in said touch screen;
receiving second touch information of a second touch event detected in a second device;
receiving device information from said second device; and
based on said first and second touch information and device information, determining whether to connect said device to said second device.

15. The device of claim 14, wherein when the first touch event and the second touch event occur simultaneously, the processor determines that said device to be connected to said second device.

16. The device of claim 14, wherein said touch information indicates a position and time of said touch event.

17. The device of claim 14, wherein said processor is further configured for determining whether said device and said second device are next to each other based on said first and second touch information and said device information.

18. The device of claim 14, wherein, when the device is determined to be connected to said second device, said processor is further configured for:
establishing connection with the second device;
forming a combined virtual screen with said display and a display of the second device;
receiving a touch input from said touch screen;
sharing said touch input with said second device; and
allowing an image to be displayed in said combined virtual screen in response to said touch input.

19. A non-transitory computer-readable medium comprising processor-executable instructions, which, while executed, cause a processor to perform:
receiving data from a first device having a first display and a second device having a second display;
based on said received data, determining to combine said first and second displays into a combined virtual screen display; and
generating instructions for said first and second devices to connect and form said combined virtual screen display,
wherein said data include a touch event detected by said first and second devices.

20. The non-transitory computer-readable medium of claim 19, wherein said processor-executable instructions, which, while executed, cause a processor to further perform:
establishing connections between said first and second devices;
detecting a touch input in said first device;
sending said touch input to said second device; and
in response to said touch input, activating a display in said combined virtual screen.
